(19) United States
(12) Patent Application Publication
(10) Pub. No.: US 2009/0317600 A1
(43) Pub. Date: Dec. 24, 2009

(54) Elastic fabric cushion structure

(76) Inventor: Chia-Ching Lee, Minsyong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,322

(22) Filed: May 7, 2009

(30) Foreign Application Priority Data
Jun. 19, 2008 (TW) 097210846

(51) Int. Cl. B32B 3/08

(52) U.S. Cl. 428/193

(57) ABSTRACT

An elastic fabric cushion structure includes an elastic fabric, an inner frame and an outer frame. The elastic fabric is in the form of a net and has a circumferential portion, a first surface and a second surface. The inner frame is flexible and molded to wrap the circumferential portion of the elastic fabric. The inner frame includes a flat portion to wrap the first surface of the elastic fabric and an oblique portion and a protruding portion to wrap the second surface of the elastic fabric. The outer frame covers the inner frame and is inflexible. The present invention enhances the connection strength of the elastic fabric and the inner frame.

### BACKGROUND OF THE INVENTION

1. Field of the Invention

The present invention relates to an elastic fabric cushion structure, and more particularly to one having an elastic fabric wrapped by a flexible inner frame which is then wrapped by an outer frame to form a cushion for furniture.

2. Description of the Prior Art

Elastic fabric is to be used on clothes. Nowadays, it is also widely used on furniture or bedding due to its breathable and flexible features. Furthermore, there are some patents for furniture cushions or bedding made of elastic fabric.

Taiwanese Utility Model Registration No. M262101 titled “a chair structure having a net as a seat or a seat back” comprises a pair of support rods at right and left inner sides of a chair frame. The net has a pair of insertion sections for insertion of the support rods. Screws are screwed into threaded holes formed in the support rods for tightening and adjusting the net.

Taiwanese Utility Model Registration No. M318366 titled “a assembled structure of a mesh seat and a seat back” comprises an L-shaped outer frame and a mesh fabric disposed on the outer frame as a seat and a seat back. A plurality of holes are formed on right and left sides of the outer frame, respectively. The holes are provided with locking members therein. Left and right sides of the mesh fabric is sewed to form tubular sleeves for insertion of two side rods. The two side rods face the right and left sides of the outer frame, and are formed with a plurality of through holes corresponding in position to the holes of the right and left sides of the outer frame. Screws are inserted through the through holes of the side rods and screwed to the right and left sides of the outer frame for tightening the mesh fabric on the outer frame to form the seat and the seat back.

The above-mentioned fastening means may be deteriorated or loosened after a period of time so the user might get hurt if the chair is not firm and steady.

### SUMMARY OF THE INVENTION

The primary objective of the present invention is to overcome the above shortcomings.

According to a first aspect of the present invention, there is provided an elastic fabric cushion structure, comprising:

an elastic fabric, the elastic fabric being in the form of a net and having a circumferential portion, a first surface and a second surface;

an inner frame, the inner frame being flexible and molded to wrap the circumferential portion of the elastic fabric, the inner frame comprising a flat portion to wrap the first surface of the elastic fabric and an oblique portion and a protruding portion to wrap the second surface of the elastic fabric; and

an outer frame, the outer frame covering the inner frame and being inflexible.

Preferably, the inner frame further comprises a restricting edge to wrap the first surface of the elastic fabric.

Preferably, the outer frame is made of either plastic or rubber.

Preferably, the outer frame comprises sleeves thereon.

Preferably, the outer frame is formed with engaging troughs therein.

According to a second aspect of the present invention, there is provided an elastic fabric cushion structure, comprising:

an elastic fabric, the elastic fabric being in the form of a net and having a circumferential portion, a first surface and a second surface;

an inner frame, the inner frame being flexible and molded to wrap the circumferential portion of the elastic fabric, the inner frame having a pair of first sides opposite to each other and a pair of second sides opposite to each other, the pair of first sides each comprising a flat portion to wrap the first surface of the elastic fabric, and an oblique portion and a protruding portion to wrap the second surface of the elastic fabric, the pair of second sides each being formed with a plurality of holes corresponding to the second surface of the elastic fabric; and

an outer frame, the outer frame covering the inner frame and being inflexible, the outer frame being provided with protuberances corresponding in position to the holes of the pair of second sides of the inner frame.

Preferably, the inner frame further comprises a restricting edge to wrap the first surface of the elastic fabric.

Preferably, the outer frame is made of either plastic or rubber.

Preferably, the outer frame comprises sleeves thereon.

Preferably, the outer frame is formed with engaging troughs therein.

The present invention has the following advantages:
1. The elastic fabric and the inner frame are connected by injection molding or lamination molding, and then integrally formed with the outer frame, so that the elastic fabric will not disengage from the inner frame nor be broken apart after a period of time.
2. The present invention may be provided with the sleeves thereon or formed with the engaging troughs therein for connecting with a chair frame, which saves time and labor.
3. The present invention is easy to manufacture, has a stronger strength, and is cost-effective.

### BRIEF DESCRIPTION OF THE DRAWINGS

FIG. 1 is a perspective view of a seat back cushion according to a first embodiment of the present invention;

FIG. 2 is a sectional view taken along line A-A of FIG. 1;

FIG. 3 is a perspective view showing an elastic fabric wrapped by an inner frame according to the first embodiment of the present invention;

FIG. 3A is an enlarged sectional view taken along a cutting area of FIG. 3;

FIG. 4 is a perspective view of a seat cushion according to the first embodiment of the present invention;

FIG. 5 is a perspective view showing the seat back cushion and the seat cushion coupled to a chair frame according to the first embodiment of the present invention;

FIG. 6 is a perspective view according to a second embodiment of the present invention;

FIG. 7 is an enlarged sectional view taken along line B-B of FIG. 6;

FIG. 8 is another enlarged sectional view taken along line C-C of FIG. 6;

FIG. 9 is a perspective view showing the elastic fabric wrapped by the inner frame according to the second embodiment of the present invention; and

FIG. 9A is an enlarged view taken along a cutting area of FIG. 9.

### DETAILED DESCRIPTION OF THE PREFERRED EMBODIMENTS

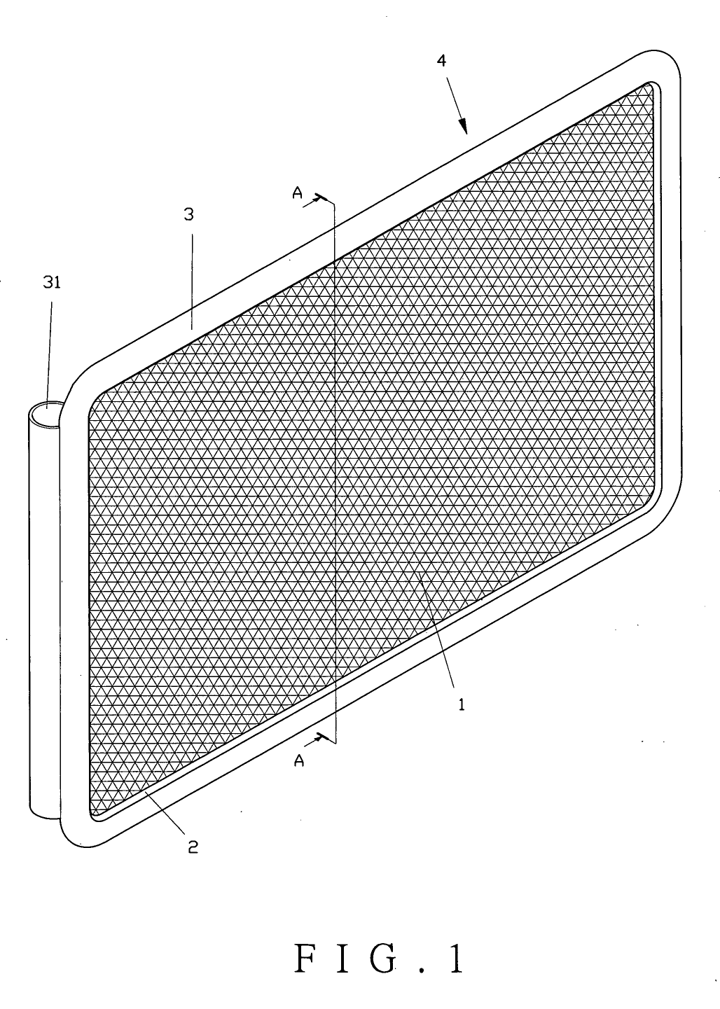

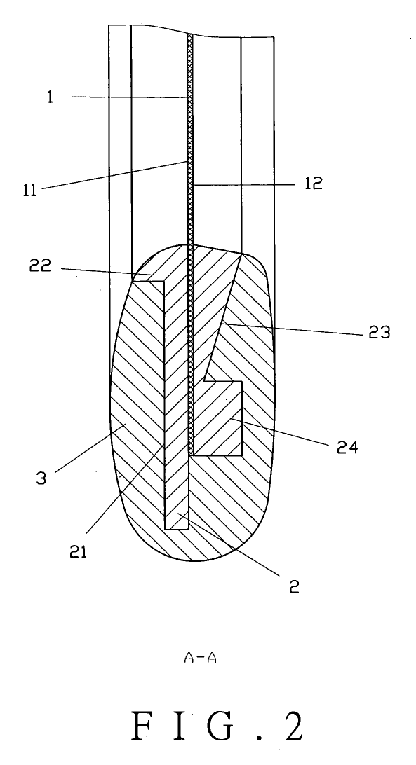

An elastic fabric cushion structure of the present invention according to a first preferred embodiment of the present invention, as shown in FIGS. 1, 2 and 3, comprises an elastic fabric 1, an inner frame 2 and an outer frame 3.

The elastic fabric 1 is in the form of a net, and has a circumferential portion, a first surface 11 and a second surface 12.

The inner frame 2 is flexible and molded to wrap the circumferential portion of the elastic fabric 1. The inner frame 2 comprises a flat portion 21 and a restricting edge 22 to wrap the first surface 11 of the elastic fabric 1, and an oblique portion 23 and a protruding portion 24 to wrap the second surface 12 of the elastic fabric 1.

The outer frame 3 is adapted to wrap the inner frame 2 and made of plastic or rubber. The outer frame 3 is inflexible.

As shown in FIG. 1, the inner frame 2 is integrally formed with the outer frame 3, and the outer frame 3 is provided with a pair of sleeves 31. The present invention is made in the form of a seat back cushion 4.

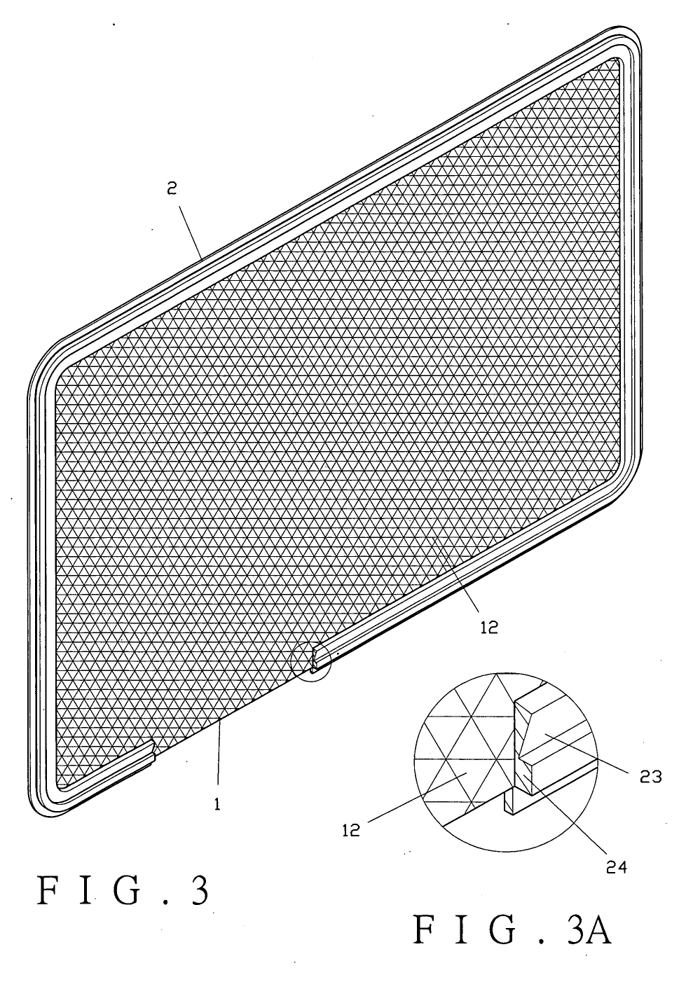

FIG. 3 is a schematic view according to the first embodiment of the present invention showing the circumferential portion of the elastic fabric 1 wrapped by the inner frame 2. FIG. 3A is an enlarge view taken along a cutting area of FIG. 3.

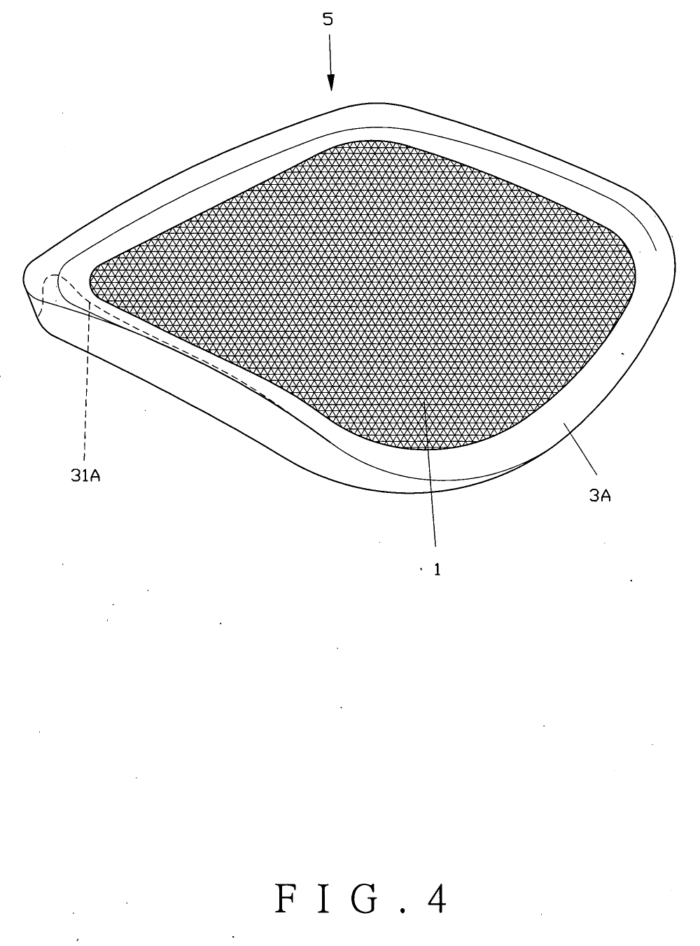

As shown in FIG. 4, the present invention is made in the form of a seat cushion 5. The bottom of the outer frame 3A is formed with a pair of engaging troughs 31A therein.

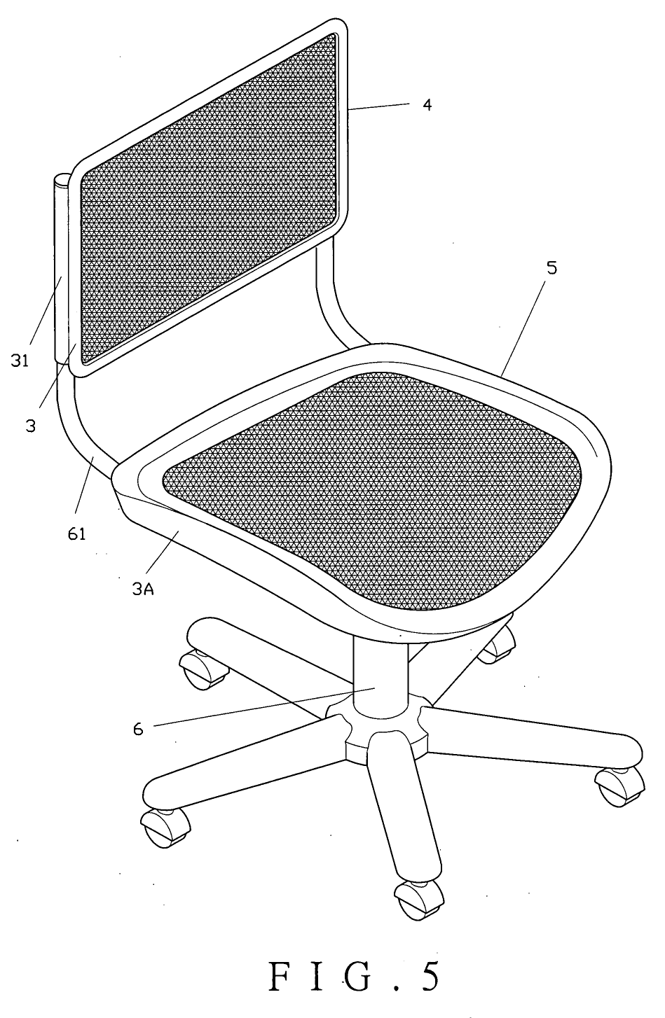

As shown in FIG. 5, the seat cushion 5 is coupled to a chair frame 6, with the engaging troughs 31A of the outer frame 3A engaging with a pair of support rods 61. The seat back cushion 4 is coupled to the pair of support rods 61, with the pairs of support rods 61 inserting into the sleeves 31 of the outer frame 3.

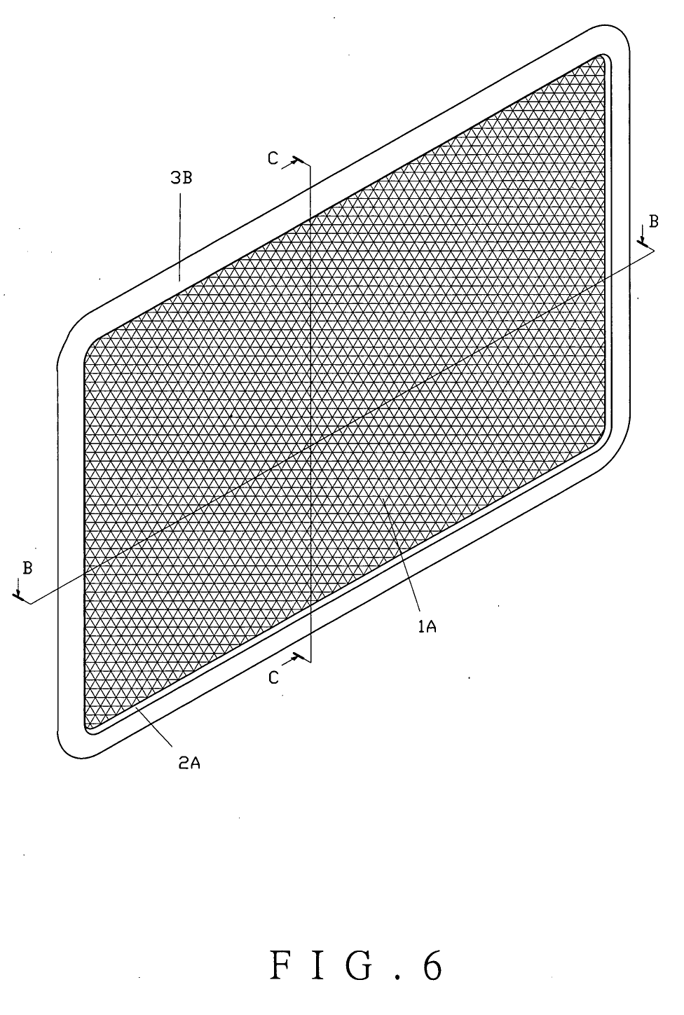

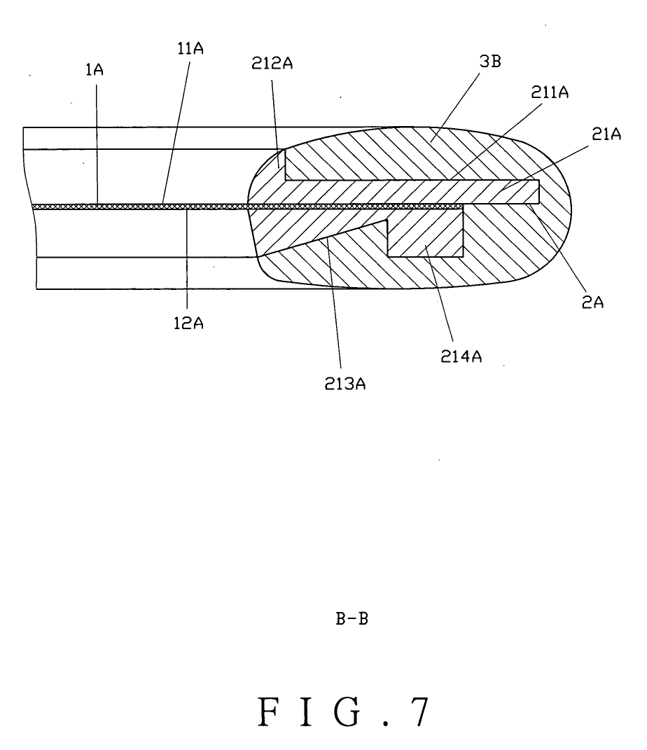

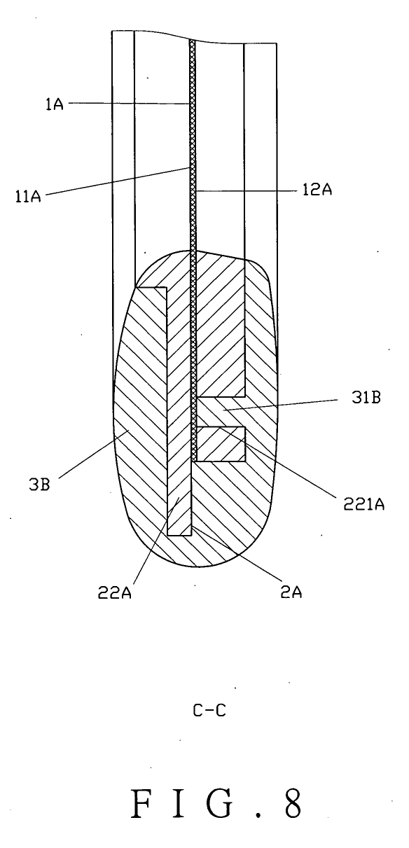

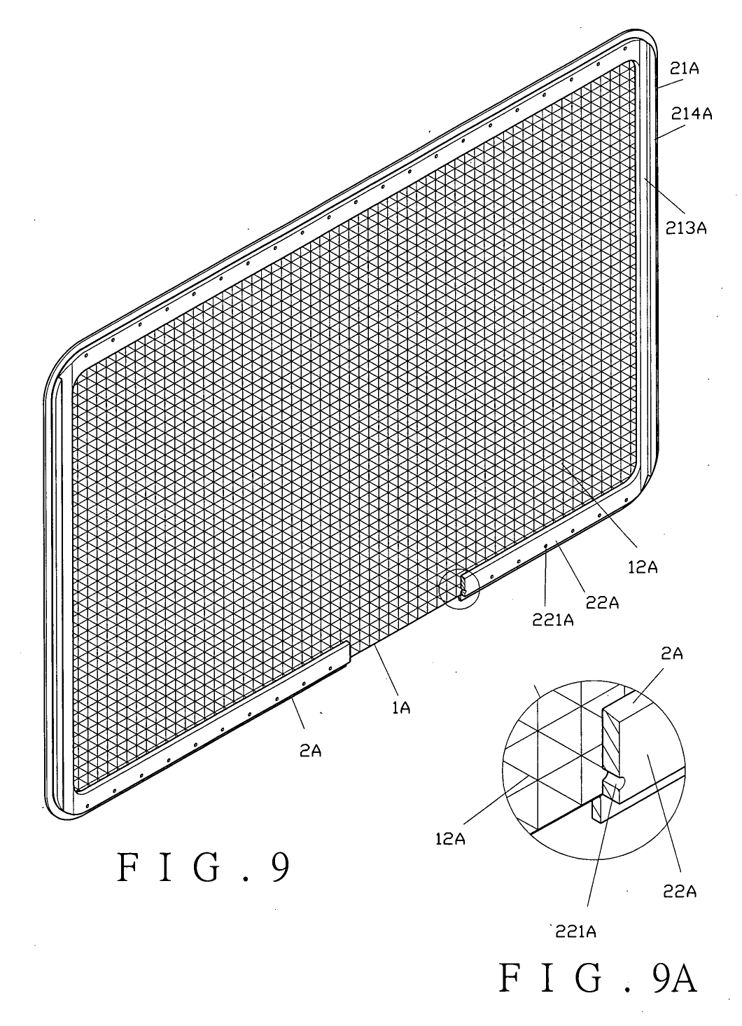

As shown in FIGS. 6 to 9, a second embodiment of the present invention comprises an elastic fabric 1A, an inner frame 2A and an outer frame 3B.

The elastic fabric 1A is in the form of a net, and has a circumferential portion, a first surface 11A and a second surface 12A.

The inner frame 2A is flexible and molded to wrap the circumferential portion of the elastic fabric 1A. The inner frame 2A has a pair of first sides 21A opposite to each other and a pair of second sides 22A opposite to each other. The pair of first sides 21A each comprises a flat portion 211A and a restricting edge 212A to wrap the first surface 11A of the elastic fabric 1A, and an oblique portion 213A and a protruding portion 214A to wrap the second surface 12A of the elastic fabric 1A. The pair of second sides 22A each is formed with a plurality of holes 221A corresponding to the second surface 12A of the elastic fabric 1A.

The outer frame 3B is adapted to wrap the inner frame 2A and is inflexible. The outer frame 3B is provided with protuberances 31B corresponding in position to the holes 221A of the pair of second sides 22A.

FIG. 6 is a perspective view of the second embodiment of the present invention showing the inner frame 2A integrally formed with the outer frame 3B. The seat cushion 5 and the seat back cushion 4 are substantially similar to the first embodiment, thus will not be described hereinafter.

The inner frames 2 and 2A of the first and second embodiments are produced by injection molding. The elastic fabric 1 is laid flat and the circumferential portion of the elastic fabric 1 is secured to the inner frame 2, 2A which is made of elastic glue. The inner frames 2 and 2A are flexible. The inner frames 2 and 2A may be produced by lamination molding.

The outer frames 3, 3A, and 3B of the first and second embodiments are also produced by injection molding. The outer frame 3, 3A, 3B takes the restricting edge 22, 212A of the inner frame 2, 2A as the boundary to wrap the flat portion 21, 211A, the oblique portions 23, 213A, and the protruding portion 24, 214A for covering the inner frame 2 and 2A to form a firm attachment. Furthermore, the outer frame 3B is formed with the protrusions 31B to engage with the plurality of holes 221A of the second embodiment, enhancing the strength of the structure.

Moreover, because the inner frame 2, 2A is made of elastic glue, the inner frame 2, 2A and the elastic fabric 1 still maintain their flexible characters after the inner frame 2, 2A and the elastic fabric 1 are connected together. This ensures the elastic fabric 1 staying flat after being connected to the inner frame 2, 2A and the outer frame 3, 3A, 3B. Due to the inflexible feature of the outer frame 3, 3A, 3B, when a force is applied to the elastic fabric 1 and the elastic fabric 1 is stretched, the inner frame 2, 2A will provide a soft and alleviate function. If the elastic fabric 1 is fixed to the outer frame 3, 3A, 3B directly, the elastic fabric 1 may disengage from the outer frame 3 after a period of time so the inner frame 2, 2A provides a buffering effect between the elastic fabric 1 and the outer frame 3.

The present invention can also be used for a bed cushion or other cushions.

What is claimed is:

1. An elastic fabric cushion structure, comprising:
an elastic fabric, the elastic fabric being in the form of a net and having a circumferential portion, a first surface and a second surface;
an inner frame, the inner frame being flexible and molded to wrap the circumferential portion of the elastic fabric, the inner frame comprising a flat portion to wrap the first surface of the elastic fabric and an oblique portion and a protruding portion to wrap the second surface of the elastic fabric; and
an outer frame, the outer frame covering the inner frame and being inflexible.

2. The elastic fabric cushion structure, as claimed in claim 1, wherein the inner frame further comprises a restricting edge to wrap the first surface of the elastic fabric.

3. The elastic fabric cushion structure, as claimed in claim 1, wherein the outer frame is made of either plastic or rubber.

4. The elastic fabric cushion structure, as claimed in claim 1, wherein the outer frame comprises sleeves thereon.

5. The elastic fabric cushion structure, as claimed in claim 1, wherein the outer frame is formed with engaging troughs therein.

6. An elastic fabric cushion structure, comprising:
an elastic fabric, the elastic fabric being in the form of a net and having a circumferential portion, a first surface and a second surface;
an inner frame, the inner frame being flexible and molded to wrap the circumferential portion of the elastic fabric, the inner frame having a pair of first sides opposite to each other and a pair of second sides opposite to each other, the pair of first sides each comprising a flat portion to wrap the first surface of the elastic fabric, and an oblique portion and a protruding portion to wrap the second surface of the elastic fabric, the pair of second sides each being formed with a plurality of holes corresponding to the second surface of the elastic fabric; and
an outer frame, the outer frame covering the inner frame and being inflexible, the outer frame being provided with protuberances corresponding in position to the holes of the pair of second sides of the inner frame.

7. The elastic fabric cushion structure, as claimed in claim 6, wherein the inner frame further comprises a restricting edge to wrap the first surface of the elastic fabric.

8. The elastic fabric cushion structure, as claimed in claim 6, wherein the outer frame is made of either plastic or rubber.

9. The elastic fabric cushion structure, as claimed in claim 6, wherein the outer frame comprises sleeves thereon.

10. The elastic fabric cushion structure, as claimed in claim 6, wherein the outer frame is formed with engaging troughs therein.
